(19) United States
(12) Patent Application Publication
(10) Pub. No.: US 2007/0044739 A1
(43) Pub. Date: Mar. 1, 2007

(54) Machine with a reciprocating piston

(75) Inventor: John Michael Clarke, Woodsboro, MD (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/213,944

(22) Filed: Aug. 30, 2005

(51) Int. Cl. F02B 75/04; F02B 75/32; F16C 7/00

(52) U.S. Cl. 123/78 F; 123/197.3

(57) ABSTRACT

A machine includes a piston disposed within a chamber. The machine may also include a rotary member rotatable about a first axis. Additionally the machine may include a linkage connecting the piston to the rotary member. The linkage may include a first link member connected to the rotary member in a manner limiting relative rotation between the first link member and the rotary member to rotation about a second axis disposed at an angle to the first axis. The linkage may also include one or more adjusters configured to adjust the linkage. Additionally, the linkage may be configured such that, during one revolution of the rotary member around the first axis, the piston undergoes a sequence of motions including a first stroke in a first direction, a second stroke in a second direction, a third stroke in the first direction, and a fourth stroke in the second direction.

### TECHNICAL FIELD

The present disclosure relates to machines with reciprocating pistons and, more particularly, to machines including a linkage connecting the piston to a rotary member.

### BACKGROUND

Many machines, such as pumps and internal combustion engines, utilize a piston that reciprocates within a chamber and displaces fluid. In such machines, the length of the strokes that the piston undergoes as it reciprocates may affect the operating characteristics of the machine. In some such machines, the piston performs different functions during different strokes. For example, in a four-cycle internal combustion engine, the piston performs a different function during each of four consecutive strokes. Depending upon the operating conditions of such an internal combustion engine, the optimal length of one or more of these four strokes may be different from the optimal length of other strokes. Unfortunately, many configurations of machines with a reciprocating piston include a linkage that only allows the piston to undergo strokes of equal length.

Published International Patent Application No. WO 94/29574 (“the '574 application”) shows a piston machine configured in such a manner to cause a piston thereof to undergo strokes of different lengths as it reciprocates within a cylinder. The piston machine of the '574 application includes a crankshaft with a journal that is disposed at an angle to a first axis about which the crankshaft rotates. The piston machine further includes a linkage connecting the crankshaft to the piston. The linkage includes a spigot assembly journalled to the journal of the crankshaft and a stirrup crank that is pivotal about a second axis that extends perpendicularly through the first axis. An outer end of the spigot assembly is connected to the stirrup crank. When the crankshaft rotates, the spigot assembly and stirrup crank rock back and fourth through an arc centered on the second axis.

The linkage further includes a connecting rod with a first end pivotally connected to the stirrup crank. From its first end, the connecting rod extends away from the second axis to a second end that is pivotally connected to the piston. As the stirrup crank rocks back and fourth, the first end of the connecting rod moves back and fourth through an arc centered on the second axis. Each time the first end of the connecting rod moves through this arc, the piston travels away from and then back toward the second axis. The centerline of the cylinder that guides the piston is offset from a center point of the arc through which the first end of the connecting rod travels. This causes the piston to travel a different distance away from the second axis than it travels toward the second axis as the first end of the connecting rod moves through the arc.

Although the piston machine of the '574 application causes the piston to undergo strokes of different lengths during each revolution of the crankshaft, certain disadvantages persist. For example, the configuration of the piston machine is such that the different length strokes that the piston undergoes all have a fixed length. Because an optimal length of each stroke of a piston may vary dependent upon operating conditions, the fixed length of the strokes of the piston of the '574 application may compromise the performance of the piston machine in some operating conditions.

The machine of the present disclosure solves one or more of the problems set forth above.

### SUMMARY OF THE INVENTION

One disclosed embodiment includes a machine, which may include a piston disposed within a chamber. The machine may also include a rotary member rotatable about a first axis. Additionally the machine may include a linkage connecting the piston to the rotary member. The linkage may include a first link member connected to the rotary member in a manner limiting relative rotation between the first link member and the rotary member to rotation about a second axis disposed at an angle to the first axis. The linkage may also include one or more adjusters configured to adjust the linkage. Additionally, the linkage may be configured such that, during one revolution of the rotary member around the first axis, the piston undergoes a sequence of motions, including a first stroke in a first direction, a second stroke in a second direction, a third stroke in the first direction, and a fourth stroke in the second direction.

Another aspect of the present disclosure relates to a method of operating a machine. The method may include rotating a rotary member about a first axis. The method may also include controlling the position of a piston within a chamber with a linkage connected between the rotary member and the piston. A first link member of the linkage may connect to the rotary member in a manner limiting relative rotation between the first link member and the rotary member to relative rotation about a second axis disposed at an angle to the first axis. Additionally, the linkage may be constructed such that, during each revolution of the rotary member around the first axis, the linkage causes the piston to undergo a sequence of motions, including a first stroke in a first direction, a second stroke in a second direction, a third stroke in the first direction, and a fourth stroke in the second direction. The method may also include adjusting the linkage to adjust the motion of the piston.

A further aspect of the present disclosure relates to a machine, which may include a rotary member, a first piston disposed within a chamber, and a first linkage connecting the first piston to the rotary member. The first linkage may connect the first piston to the rotary member in such a manner to cause the first piston to reciprocate during rotation of the rotary member. Additionally, the first linkage may include one or more adjusters configured to adjust the first linkage. The machine may also include a second piston disposed within a second chamber and a second linkage connecting the second piston to the rotary member in such a manner to cause the second piston to reciprocate during rotation of the rotary member. The second linkage may be non-adjustable.

### BRIEF DESCRIPTION OF THE DRAWINGS

FIG. 1A is a diagrammatic illustration of one embodiment of a machine according to the present disclosure, showing a first stage of operation of the machine;

FIG. 1B is a diagrammatic illustration showing a second stage of operation of the machine of FIG. 1A;

FIG. 1C is a diagrammatic illustration showing a third stage of operation of the machine of FIG. 1A;

FIG. 1D is a diagrammatic illustration showing a fourth stage of operation of the machine of FIG. 1A;

FIG. 2 is a graphical illustration of motion of a piston of the machine of FIGS. 1A-1D in a first operating state;

FIG. 3 is a graphical illustration of motion of the piston of the machine of FIGS. 1A-1D in a second operating state;

FIG. 4 is a diagrammatic illustration of another embodiment of a machine according to the present disclosure; and

FIG. 5 is a diagrammatic illustration of another embodiment of a machine according to the present disclosure.

### DETAILED DESCRIPTION

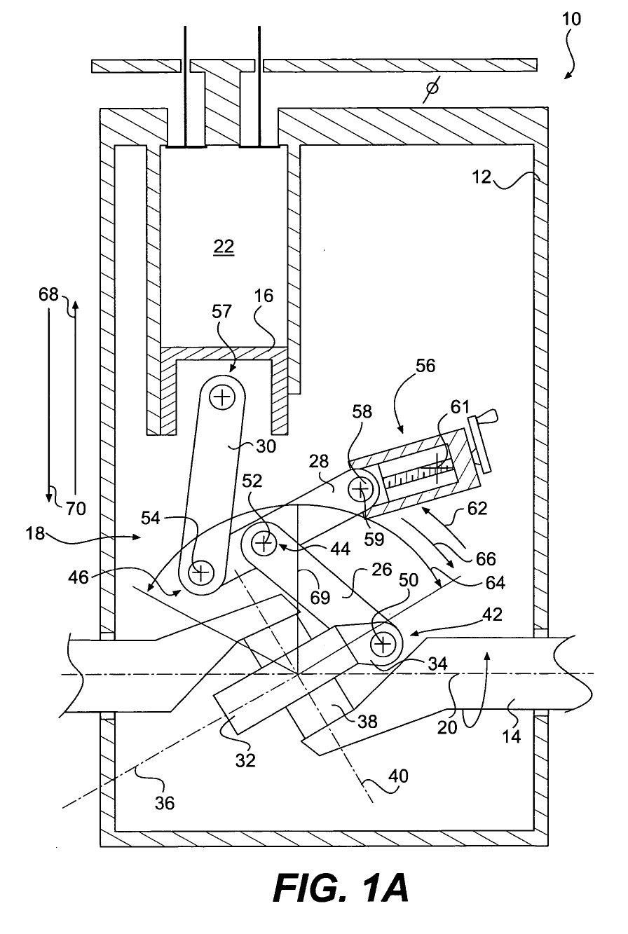

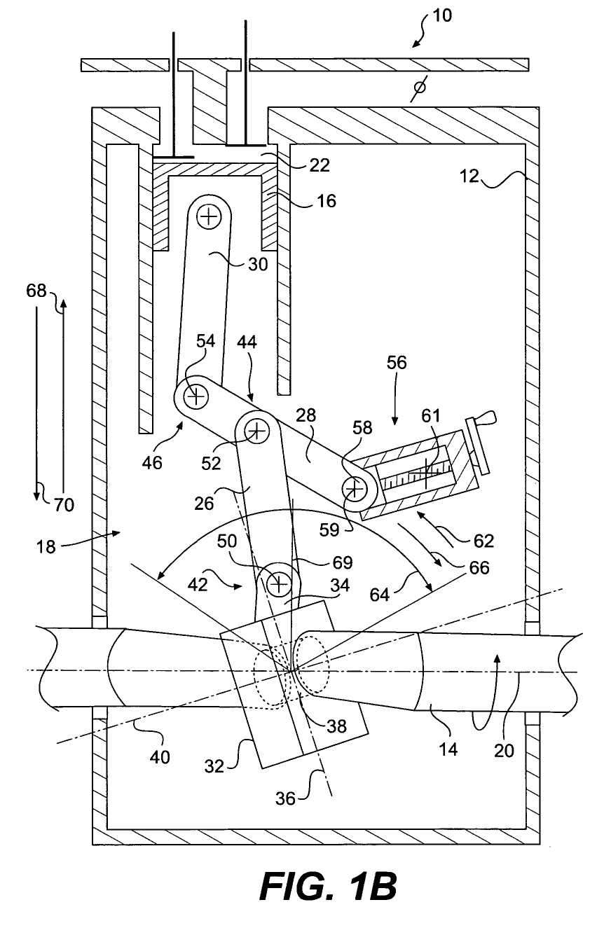

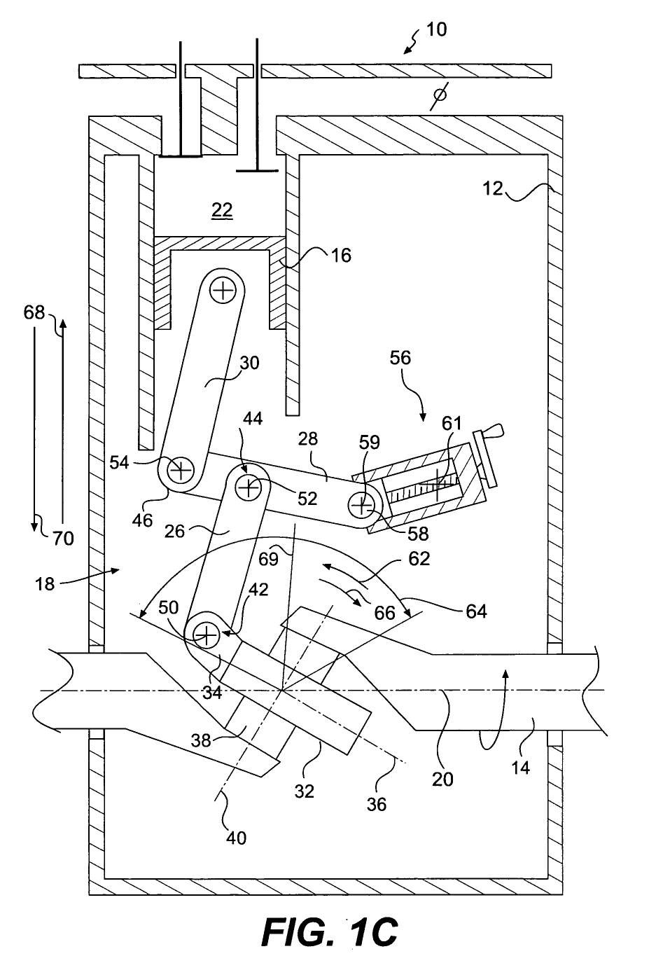

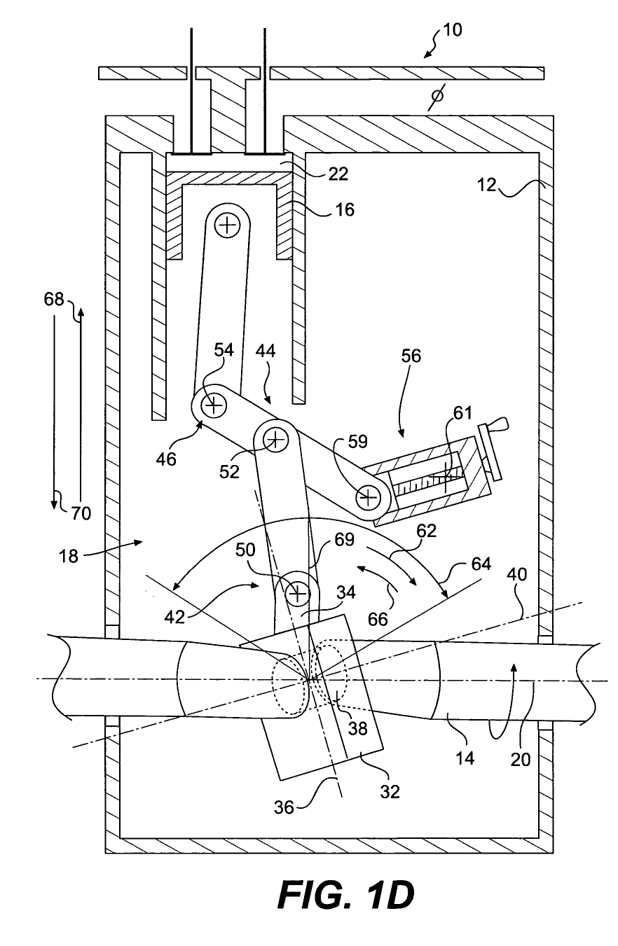

FIG. 1A is an illustration of one embodiment of a machine 10 according to the present invention. Machine 10 may include a housing 12, a rotary member 14, a piston 16, and a linkage 18. Machine 10 may be any type of machine that employs a reciprocating piston 16, including, but not limited to, an internal combustion engine, an external combustion engine, and a pump.

Housing 12 may provide support for rotary member 14 and piston 16. Housing 12 may support rotary member 14 in such a manner that rotary member 14 may rotate about a rotation axis 20. Piston 16 may be slideably supported within a chamber 22 of housing 12.

Linkage 18 may include link members 26, 28, 30, 32, and 34 connecting piston 16 to rotary member 14. Link members 32 and 34 may be connected to one another in a manner limiting relative movement between them to relative rotation about an axis 36. Rotary member 14 may be connected to link member 32 in a manner limiting relative rotation between rotary member 14 and link member 32 to relative rotation about an axis 40 disposed at an angle to both rotation axis 20 and axis 36. For example, rotary member 14 may include a journal 38 that extends along axis 40 and through a bore (not shown) in link member 32. Such a connection may create a fixed angular relationship between axis 36 and axis 40.

Link members 26, 28, 30, and 34 may connect to one another through pin joints 42, 44, 46. Each pin joint 42, 44, 46 may limit relative motion between a pair of link members 26, 28, 30, and 34 connected thereby to rotation around an axis 50, 52, 54. A pin joint 57 may similarly pivotally connect link member 30 to piston 16.

Additionally, linkage 18 may include an adjuster 56 for adjusting linkage 18. Adjuster 56 may be any type of mechanism configured to adjust the kinetics of linkage 18, such as by locating adjustable stationary pivot 58. Adjuster 56 may include a power actuator, such as an electric, hydraulic, or pneumatic actuator, and/or manually actuated mechanisms for adjusting linkage 18. In some embodiments, adjuster 56 may include one or more adjustable stationary guides, such as an adjustable stationary pivot 58. An adjustable stationary guide is a guide that may be held stationary while rotary member 14, linkage 18, and piston 16 are in motion, but that may also be selectively moved to adjust linkage 18. As is shown in FIG. 1A, link member 28 may be pivotally connected to adjustable stationary pivot 58. Adjuster 56 may be configured such that adjustable stationary pivot 58 may be moveable to two or more positions. For example, adjustable stationary pivot 58 may be moveable through a range of positions including a position 59, where it is shown in FIG. 1A, and a position 61. Moving adjustable stationary pivot 58 between position 59 and position 61 may change a distance between pin joint 44 and a centerline 69 of sweep angle 64.

FIGS. 1B-D each illustrate machine 10 of FIG. 1A in another stage of operation. Each of FIGS. 1A-1D shows machine 10 with rotary member 14 disposed at a different angular orientation about rotation axis 20. FIG. 1B shows rotary member advanced slightly more than 90 degrees from the position shown in FIG. 1A. FIG. 1C shows rotary member 14 advanced 180 degrees from the position shown in FIG. 1A. And FIG. 1D shows rotary member 14 advanced slightly less than 270 degrees from the position shown in FIG. 1A.

Movement of link members 32, 34 may accompany rotation of rotary member 14 around rotation axis 20. As rotary member 14 rotates 180 degrees from the position shown in FIG. 1A, axis 40 may move from the angular orientation shown in FIG. 1A, through a range of angular orientations, to the angular orientation shown in FIG. 1C. Because of the fixed angular relationship between axis 36 and axis 40, the angular orientation of link member 32, axis 36, and link member 34 must change in concert with these changes in the angular orientation of axis 40.

Pin joint 42 may dictate that such changes in the angular orientation of link member 32, axis 36, and link member 34 are in the form of link member link member 32, axis 36, and link member 34 rocking forward and back once through a sweep angle 64 during each revolution of rotary member 14. Pin joint 42 may allow movement of link member 34 and axis 36 only within a plane perpendicular to axis 50. As a result, as rotary member 14 rotates 180 degrees from the position shown in FIG. 1A, link member 32, link member 34, and axis 36 may sweep within this plane in direction 62, through sweep angle 64, to the position shown in FIG. 1C. As rotary member 14 subsequently rotates 180 degrees in the same direction, link member 32, link member 34, and axis 36 may sweep within the same plane in direction 66, through sweep angle 64, back to the position shown in FIG. 1A. Additionally, as rotary member 14 rotates around rotation axis 20, an angle between axis 40 and the plane that axis 36 moves in may change. As a result, as link member 32, link member 34, and axis 36 sweep back and forth through sweep angle 64, link member 32 may undergo oscillatory rotation about axis 36, while pin joint 42 prevents rotation of link member 34 about axis 36.

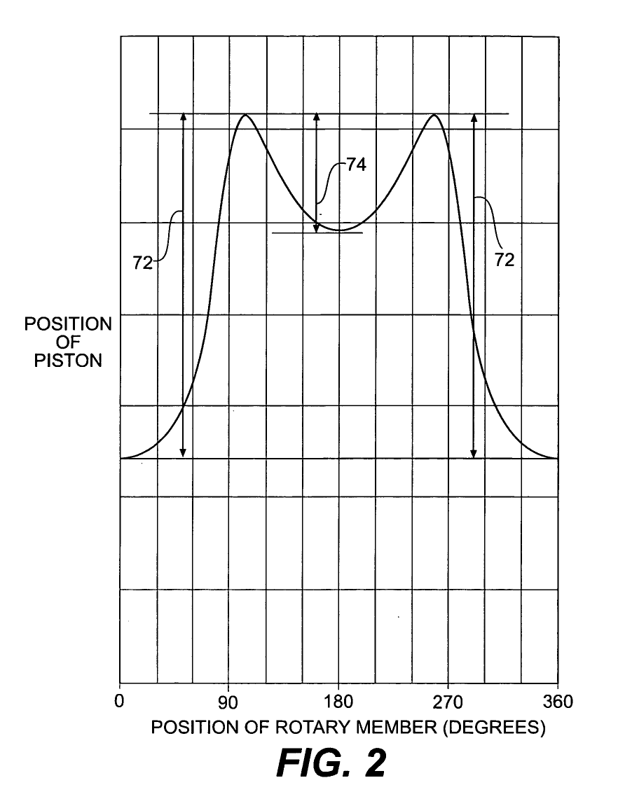

As link members 32, 34 sweep forward and back once through sweep angle 64, link members 26, 28, and 30 may cause piston 16 to reciprocate twice within chamber 22. As link members 32, 34 sweep in direction 62 from the position shown in FIG. 1A, link members 26, 28, and 30 may drive piston 16 through a first stroke in direction 68. As is shown in FIG. 1B, link members 26, 28, and 30 may be configured and associated with one another and piston 16 in such a manner to drive piston 16 to its furthest point in direction 68 when link members 32, 34 are disposed between outer bounds of sweep angle 64. Thus, as link members 32, 34 continue sweeping in direction 62, link members 26, 28, and 30 may allow piston 16 to move through a second stroke in direction 70, to the position shown in FIG. 2C. Subsequently, when link members 32, 34 reverse and sweep in direction 66, link members 26, 28, 30 may again drive piston 16 in direction 68, through a third stroke, to the position shown in FIG. 1D. Finally, as link members 32, 34 continue sweeping in direction 66, link members 26, 28, 30 may allow piston 16 to again move in direction 70, through a fourth stroke, back to the position shown in FIG. 1A.

FIG. 2 graphically illustrates the position of piston 16 as a function of the position of rotary member 14 when adjustable stationary pivot 58 is disposed at position 59. The position of rotary member 14 shown in FIG. 1A constitutes the 0 degree position of FIG. 2. With adjustable stationary pivot 58 disposed in any one position, the embodiment of linkage 18 shown in FIGS. 1A-1D may cause the first and fourth strokes of piston 16 to have an equal length 72 and the second and third strokes of piston 16 to have an equal length 74. However, when adjustable stationary pivot 58 is disposed at position 59, length 72 of the first and fourth strokes may be different from length 74 of the second and third strokes. Locating adjustable stationary pivot 58 at position 59 causes a difference between length 72 of the first and fourth strokes and length 74 of the second and third strokes because it places pin joint 44 at a distance from centerline 69 of sweep angle 64.

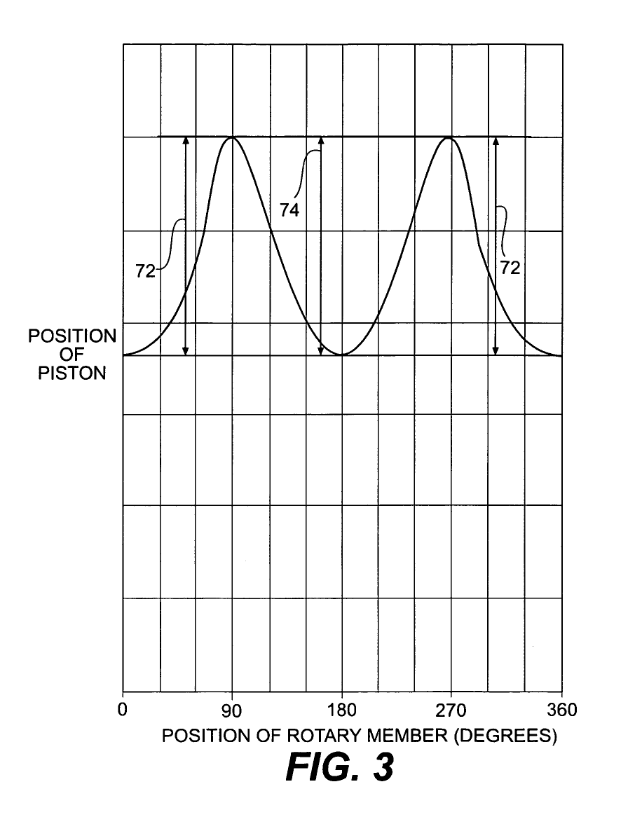

FIG. 3 graphically illustrates the position of piston 16 as a function of the position of rotary member 14 when adjustable stationary pivot 58 is disposed at position 61. With adjustable stationary pivot 58 at position 61, pin joint 44 may be approximately on centerline 69 of sweep angle 64. As FIG. 3 illustrates, this may cause length 72 of the first and fourth strokes to be approximately equal to length 74 of the second and third strokes. Thus, the ratio of length 74 of the second and third strokes to length 72 of the first and fourth strokes may be greater when adjustable stationary pivot 58 is at position 61 than when it is at position 59. Additionally, position 61 of adjustable stationary pivot 58 may provide a greater length 74 of the second and third strokes than position 59 does. Length 72 of the first and fourth strokes, length 74 of the second and third strokes, and the ratio of length 74 to length 72 may vary continuously as the position of adjustable stationary pivot 58 moves between position 59 and position 61.

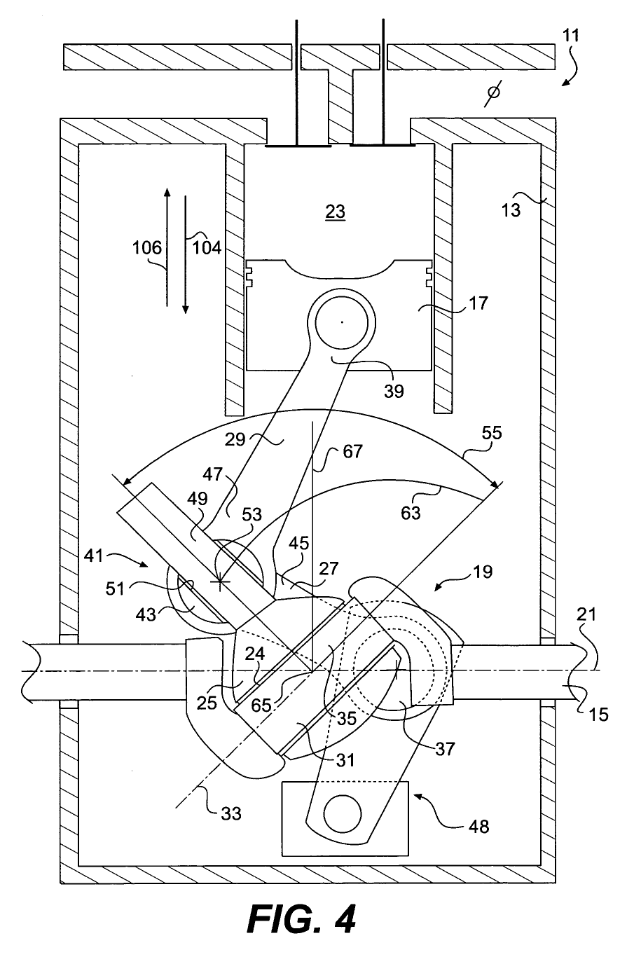

FIG. 4 illustrates another embodiment of a machine 11 according to the present disclosure. Machine 11 may include a housing 13, a rotary member 15, a piston 17, and a linkage 19 connecting piston 17 to rotary member 15. Housing 13 may support rotary member 15 in such a manner that rotary member 15 may rotate around a rotation axis 21. Housing 13 may further include a chamber 23 within which piston 17 may be slideably disposed.

Linkage 19 may include link members 25, 27, and 29. Link member 25 may be connected to rotary member 15 in a manner limiting relative rotation between link member 25 and rotary member 15 to relative rotation about an axis 33 disposed at an angle to rotation axis 21. For example, rotary member 15 may include a journal 31 that extends along axis 33 and through a bore 24 in link member 25. An end 35 of link member 27 may be connected to an adjustable stationary pivot 37 of an adjuster 48. A pin joint may connect an end 39 of link member 29 to piston 17.

Link members 25, 27, and 29 may be connected to one another at a joint 41, which may include a pin 43. An end 45 of link member 27 may be pivotally engaged to pin 43. An end 47 of link member 29 may also be pivotally engaged to pin 43. A portion 49 of link member 25 may be slideably disposed within an aperture 51 extending through pin 43 in a direction perpendicular to an axis 53 of pin 43. Thus, joint 41 may limit relative movement between link members 25, 27, and 29 to pivoting about axis 53 of pin 43 and sliding of ends 45, 47 of link members 27, 29 in a direction perpendicular to axis 53 relative to link member 25.

Like linkage 18 (FIG. 1A), linkage 19 may cause piston 17 to undergo four strokes in alternating directions during each revolution of rotary member 15. Pin 43 may limit movement of link member 25 to movement within a plane perpendicular to axis 53. This constraint on link member 25, in combination with the above-described connection of link member 25 and rotary member 15, may cause link member 25 to sweep forward and back once through a sweep angle 55 during each revolution of rotary member 15.

As link member 25 sweeps back and forth, pin 43, end 45 of link member 27, and end 47 of link member 29 may move with link member 25. Because link member 27 is connected to adjustable stationary pivot 37, link member 27 may dictate that pin 43 travel along an arc 63 centered on adjustable stationary pivot 37. If adjustable stationary pivot 37 is disposed at a distance from a vertex 65 of sweep angle 55, link member 27 may cause pin 43 to slide along link member 25 toward and away from vertex 65 as link member 25 sweeps back and forth. As pin 43 travels forward and back once on arc 63, link member 29 may cause piston 17 to undergo a first stroke in a direction 106, a second stroke in a direction 104, a third stroke in direction 106, and a fourth stroke in direction 104.

Adjustable stationary pivot 37 may be utilized to change the lengths of various strokes and also ratios of the lengths of various strokes of piston 17. When adjustable stationary pivot 37 is disposed at a distance from a centerline 67 of sweep angle 55, arc 63 may extend asymmetrically about centerline 67. This may produce a difference between a length of the first stroke and the length of the third stroke of piston 17 and also a difference between a length of the second stroke and the length of the fourth stroke of piston 17. The greater the distance between adjustable stationary pivot 37 and centerline 67 of sweep angle 55, the greater these differences may be. Accordingly, moving adjustable stationary pivot 37 away from centerline 67 of sweep angle 55 may increase a ratio of the length of the first stroke to the length of the third stroke and may also increase a ratio of the length of the second stroke to the length of the fourth stroke. Conversely, moving adjustable stationary pivot 37 toward centerline 67 may decrease these ratios.

Machines 10, 11 are not limited to the configurations illustrated in FIGS. 1A-1D and 4. For example, linkages 18, 19 may include additional link members and/or omit one or more of link members 25-30, 32, and 34. Additionally, other types of joints, such as ball and socket joints, sliding joints, and lost-motion joints, may be utilized to connect link members 25-30, 32, 34, and any other link members of linkages 18, 19. Furthermore, adjusters 56, 48 may connect to different link members. Moreover, linkage 18 may include other adjusters in addition to adjuster 56 and linkage 19 may include other adjusters in addition to adjuster 48. For example, linkages 18, 19 may include adjusters configured to adjust the shape or size of one or more link members 25-30, 32, 34.

Machines 10, 11 may also have different configurations that cause pistons 16, 17 to reciprocate twice during each revolution of rotary members 14, 15 around rotation axes 20, 21. Machine 10 may employ one or more devices other than pin joint 42 to limit rotation of link members 32, 34 about rotation axis 20 and, thereby, cause link members 32, 34 to sweep back and forth through sweep angle 64 during rotation of rotary member 14. For example, a guide slot may be employed to limit rotation of link members 32, 34 about rotation axis 20. Additionally, a device may limit rotation of link members 32, 34 about rotation axis 20 and, thereby, cause link members 32, 34 to sweep back and forth through sweep angle 64, without necessarily constraining link members 32, 34 to move within a plane. Similar to machine 10, machine 11 may implement one or more devices other than pin 43 for limiting rotation of link member 25 about rotation axis 21 and, thereby, causing link member 25 to sweep back and forth through sweep angle 55. Furthermore, linkages 18, 19 may include other configurations of link members that cause pistons 16, 17 to be at extremes of their travel when link members 32, 34, 25 are disposed between outer bounds of sweep angles 64, 55.

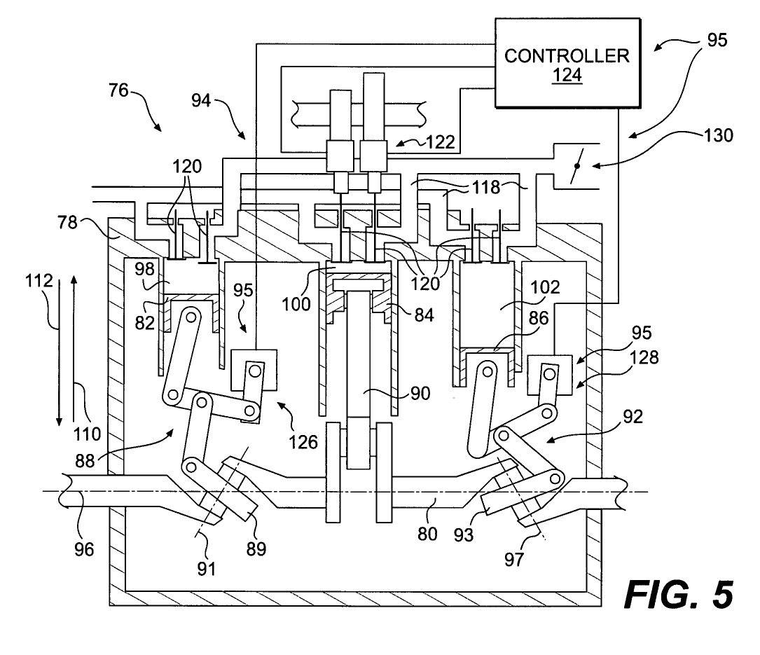

FIG. 5 shows another embodiment of a machine 76 according to the present disclosure. Machine 76 may be an internal combustion engine. Machine 76 may include a housing 78, a rotary member 80, pistons 82, 84, 86, linkages 88, 90, 92, an aspiration system 94, and engine controls 95.

Housing 78 may provide support for pistons 82, 84, 86 and rotary member 80. Housing 78 may include chambers 98, 100, 102, within which pistons 82, 84, 86 may be slideably supported. Housing 78 may support rotary member 80 in such a manner that rotary member 80 may rotate around a rotation axis 96.

Linkages 88, 90, 92 may connect pistons 82, 84, 86 to rotary member 80. Like linkage 18 (FIG. 1A), linkage 88 may include a link member 89 connected to rotary member 80 in a manner limiting relative rotation between link member 89 and rotary member 80 to relative rotation about an axis 91 disposed at an angle to rotation axis 96. Similarly, a link member 93 of linkage 92 and rotary member 80 may be connected in a manner limiting relative rotation between link member 93 and rotary member 80 to relative rotation about an axis 97 disposed at an angle to rotation axis 96.

Additionally, like linkage 18 of machine 10, linkages 88, 92 may be configured to cause pistons 82, 86 to undergo a first stroke in a direction 110, a second stroke in a direction 112, a third stroke in direction 110, and a fourth stroke in direction 112, during a single revolution of rotary member 80 around rotation axis 96. Furthermore, like linkage 18, each linkage 88, 92 may include an adjuster 126, 128 configured to provide adjustment of the motion of a respective piston 82, 86, including adjustment of a ratio of the length of its second stroke to the length of its fourth stroke. Linkage 90 may be non-adjustable and configured to cause piston 84 to reciprocate only once during each revolution of rotary member 80 around rotation axis 96.

Aspiration system 94 may be configured to deliver air to, and exhaust combustion gases from, chambers 98, 100, 102. Aspiration system 94 may include channels 118, valves 120, and a chamber-deactivation system 122. Chamber-deactivation system 122 may be operable to selectively prevent aspiration of chamber 100, including preventing delivery of air to chamber 100 and preventing expulsion of gas from chamber 100. In some embodiments, chamber-deactivation system 122 may prevent aspiration of chamber 100 by maintaining both valves 120 associated therewith closed.

Engine controls 95 may be configured to control various aspects of operation of machine 76. Engine controls 95 may include a controller 124, adjusters 126, 128, and a throttle 130. Controller 124 may be operatively connected to adjusters 126, 128 and configured to cause adjusters 126, 128 to adjust linkages 88, 92 dependent upon operating conditions of machine 76. Additionally, controller 124 may be operatively connected to chamber-deactivation system 122 and configured to selectively cause chamber-deactivation system 122 to prevent aspiration of chamber 100. Throttle 130 may be configured to control the rate at which aspiration system 94 provides air to chambers 98, 100, 102.

### INDUSTRIAL APPLICABILITY

Machines 10, 11, and 76 may have application in any system where a reciprocating piston connected to a rotary member may be beneficially employed. For example, machines 10, 11, and 76 may be utilized as pumps, external combustion engines, or internal combustion engines.

In some embodiments, machines 10, 11 may be four-cycle internal combustion engines and the first, second, third, and fourth strokes described above may be an exhaust stroke, an intake stroke, a compression stroke, and a power stroke, respectively. During the exhaust stroke, piston 16, 17 may purge chamber 22, 23 by driving any gases, such as combustion gases from a previous power stroke, out of chamber 22, 23. During the intake stroke, air or an air/fuel mixture may be directed into chamber 22, 23. Piston 16, 17 may compress the air or air/fuel mixture during the compression stroke. Fuel and air may be combusted in chamber 22, 23 to drive piston 16, 17 through the power stroke.

In embodiments where machines 10, 11 are internal combustion engine, the lengths of various strokes of pistons 16, 17 may affect the power capacity and efficiency of machines 10, 11. For example, the greater a length of an intake stroke of a respective piston 16, 17 is, the greater the power capacity of the respective machine 10, 11 may be. Additionally, the lower a ratio of a length of the intake stroke to the length of the power stroke of a respective piston 16, 17 is, the greater the efficiency of the respective machine 10, 11 may be.

Thus, the state of adjustment of linkages 18, 19 may affect the efficiency and/or power capacity of machines 10, 11 operating as internal combustion engines. For example, in embodiments of machine 10 where the first, second, third, and fourth strokes are an exhaust, intake, compression, and power stroke, position 59 of adjustable stationary pivot 58 may provide higher efficiency, and position 61 may provide higher power capacity. In such embodiments, the lower ratio of length 74 of the intake stroke to length 72 of the power stroke when adjustable stationary pivot 58 is in position 59 may give machine 10 a higher efficiency. However, the greater length 74 of the intake stroke when adjustable stationary pivot 58 is at position 61 may give machine 10 higher power capacity. In embodiments where machine 11 is operated as an internal combustion engine, adjusting the position of adjustable stationary pivot 37, and thereby changing a length of the intake stroke and/or a ratio of the length of the intake stroke to a length of the exhaust stroke, may similarly affect the power capacity and/or efficiency of machine 11. Thus, linkages 18, 19 may provide flexibility to adjust operation of machines 10, 11 to changing conditions.

This flexibility may be employed by adjusting linkage 18 or linkage 19 dependent at least in part upon the amount of power required from machine 10 or machine 11. For example, when there is a relatively low need for power from machine 10, adjustable stationary pivot 58 may be placed at position 59 to provide high efficiency. When power requirements are higher, adjustable stationary pivot 58 may be moved to position 61 to increase the power capacity of machine 10. Similarly, during operation of machine 11 linkage 19 may be utilized to adjust a ratio of the length of the intake stroke to a length of the power stroke to a relatively low value when power requirements are low and to a relatively high value when power requirements are higher.

Additionally, the disclosed embodiments of machines 10, 11 may combine the above-described operating efficiency with a relatively high power capacity for a given size of machine 10. Because linkages 18, 19 allow adjusting the ratio of the length of the intake stroke to the length of the power stroke, the length of the intake stroke may be increased without increasing the length of the power stroke. As a result, power capacity increases can be accomplished without housings 12, 13 needing to be large enough to allow lengthening of the power stroke. Additionally, causing pistons 16, 17 to reciprocate twice during each revolution of respective rotary members 14, 15 may allow linkages 18, 19 to provide adjustment of the ratio of the length of the intake stroke to the length of the power stroke. Furthermore, embodiments of linkages 18, 19 wherein link members 32, 34, 25 sweep forward and back once through respective sweeps angle 64, 55 during each revolution of respective rotary members 14, 15 may be a relatively compact way to provide four strokes of pistons 16, 17 during each revolution of a respective rotary member 14, 15.

The disclosed configurations of machines 10, 11 also facilitate smooth, reliable adjustment of linkages 18, 19 during rotation of rotary members 14, 15. Gradual changes in the kinetic relationships between rotary members 14, 15 and pistons 16, 17 may be effected by gradually changing the position of adjustable stationary pivots 58, 37. Additionally, adjusting the position of adjustable stationary guides, such as adjustable stationary pivots 58, 37, is a simple, robust way to adjust linkages 18, 19 when they are in motion.

Like machines 10, 11, machine 76 may be utilized as an internal combustion engine. In some embodiments, machine 76 may operate as a four-cycle internal combustion engine. Each of linkages 88, 92 may be adjusted to adjust a length of an intake stroke and/or a ratio of a length of the intake stroke to a length of a power stroke of a respective piston 82, 86.

In contrast to linkages 88 and 92, linkage 90 may not be adjusted to change the motion of piston 84. However, because linkage 90 may have a relatively compact size, linkage 90 may contribute to machine 76 having a relatively high power capacity for its size. Thus, a combination of linkages 88, 92 connecting pistons 82, 86 to rotary member 80 and non-adjustable linkage 90 connecting piston 84 to rotary member 80 may provide machine 76 with a desirable combination of operating flexibility and power density.

Chamber-deactivation system 122 may allow additional flexibility in tailoring operation of machine 76 to changing operating conditions. When power requirements are low, chamber deactivation system 122 may be utilized to prevent aspiration of chamber 100. Preventing aspiration of chamber 100 may improve the efficiency of machine 76 by eliminating pumping losses associated with aspirating chamber 100.

In some embodiments, engine controls 95 may automatically control the adjustment of linkages 88, 92 and whether chamber-deactivation system 122 prevents aspiration of chamber 100. When power requirements are relatively high, controller 124 may cause adjusters 126, 128 to adjust linkages 88, 92 to provide relatively high ratios of the lengths of the intake strokes of pistons 82, 86 to the lengths of their power strokes. Controller 124 may simultaneously cause chamber-deactivation system 122 to allow aspiration of chamber 100. When power requirements are relatively low, controller 124 may cause adjusters 126, 128 to adjust linkages 88, 92 to provide lower ratios of the lengths of the intake strokes of pistons 82, 86 to the lengths of their power strokes. Controller 124 may simultaneously cause chamber-deactivation system 122 to prevent aspiration of chamber 100.

The configuration of machine 76 shown in FIG. 5 may also provide certain advantages related to noise, vibration, and harshness. During rotation of rotary member 80 around rotation axis 96, linkage 88 and piston 82 may exert a different pattern of dynamic forces on housing 78 and rotary member 80 than linkage 90 and piston 84. However, linkage 92 and piston 86 may exert a pattern of dynamic forces on housing 78 and rotary member 80 similar to the pattern of dynamic forces applied thereto by linkage 88 and piston 82. Placing linkage 92 and piston 86 on a side of linkage 90 and piston 84 opposite linkage 88 and piston 82 may promote symmetry of the dynamic forces applied to housing 78 and rotary member 80.

It will be apparent to those skilled in the art that various modifications and variations can be made in the disclosed machines 10, 11, and 76 without departing from the scope of the disclosure. Other embodiments of the disclosed machines 10, 11, and 76 will be apparent to those skilled in the art from consideration of the specification and practice of the machines 10, 11, and 76 disclosed herein. It is intended that the specification and examples be considered as exemplary only, with a true scope of the disclosure being indicated by the following claims and their equivalents.

What is claimed is:

1. A machine, comprising:
a piston disposed within a chamber;
a rotary member rotatable around a first axis; and
a linkage connecting the piston to the rotary member, including:
a first link member connected to the rotary member in a manner limiting relative rotation between the first link member and the rotary member to rotation about a second axis disposed at an angle to the first axis; and
one or more adjusters configured to adjust the linkage; and
wherein the linkage is configured such that, during one revolution of the rotary member around the first axis, the piston undergoes a sequence of motions, including:
a first stroke in a first direction;
a second stroke in a second direction;
a third stroke in the first direction; and
a fourth stroke in the second direction.

2. The machine of claim 1, wherein the one or more adjusters are configured to allow adjustment of a ratio of a length of the second stroke to a length of the fourth stroke.

3. The machine of claim 1, wherein the first link member is constrained to sweep forward and back once through a sweep angle during a full revolution of the rotary member around the first axis.

4. The machine of claim 3, wherein:
the one or more adjusters include an adjustable stationary pivot; and
the linkage further includes a second link member pivotally connected to the adjustable stationary pivot.

5. The machine of claim 3, wherein:
the linkage further includes a second link member connected to the first link member through a joint; and
the one or more adjusters are configured to allow adjustment of the position of the joint toward and away from a centerline of the sweep angle.

6. The machine of claim 3, wherein:
the linkage includes a second link member with a portion thereof connected to the first link member in such a manner to allow pivoting and sliding between the first link member and the second link member;
the portion of the second link member that is connected to the first link member is constrained to travel along a curve; and
the one or more adjusters are configured to allow asymmetrical adjustment of the distribution of the curve with respect to a centerline of the sweep angle.

7. The machine of claim 3, wherein the linkage is configured in such a manner that the piston is at one extreme of its travel when the first link member is disposed between outer bounds of the sweep angle.

8. The machine of claim 1, wherein:
the one or more adjusters are configured to allow a first state of adjustment of the linkage, the first state of adjustment providing a first ratio of a length of the second stroke to a length of the fourth stroke; and
the one or more adjusters are configured to allow a second state of adjustment of the linkage, the second state of adjustment providing a second ratio, greater than the first ratio, of the length of the second stroke to the length of the fourth stroke.

9. The machine of claim 8, wherein:
the machine is a four-stroke internal combustion engine;
the first stroke is an exhaust stroke;
the second stroke is an intake stroke;
the third stroke is a compression stroke; and
the fourth stroke is a power stroke.

10. The machine of claim 1, wherein:
the machine is a four-stroke internal combustion engine;
the first stroke is an exhaust stroke;
the second stroke is an intake stroke;
the third stroke is a compression stroke; and
the fourth stroke is a power stroke.

11. The machine of claim 1, wherein:
the one or more adjusters include an adjustable stationary pivot; and
the linkage further includes a second link member pivotally connected to the adjustable stationary pivot.

12. The machine of claim 1, wherein the one or more adjusters include one or more adjustable stationary guides.

13. A method of operating a machine, comprising:
rotating a rotary member around a first axis;
controlling the position of a piston within a chamber with a linkage connected between the rotary member and the piston, wherein:
a first link member of the linkage connects to the rotary member in a manner limiting relative rotation between the first link member and the rotary member to relative rotation about a second axis disposed at an angle to the first axis; and
the linkage is configured such that, during each revolution of the rotary member around the first axis, the linkage causes the piston to undergo a sequence of motions, including:
a first stroke in a first direction;
a second stroke in a second direction;
a third stroke in the first direction;
a fourth stroke in the second direction; and
adjusting the linkage to adjust the motion of the piston.

14. The method of claim 13, wherein adjusting the linkage to adjust the motion of the piston includes adjusting the linkage to adjust a ratio of a length of the second stroke to a length of the fourth stroke.

15. The method of claim 14, further including:
directing air into the chamber during the second stroke;
compressing the air in the chamber with the piston during the third stroke; and
combusting fuel in the chamber to drive the piston through the fourth stroke.

16. The method of claim 15, wherein adjusting the linkage to adjust the motion of the piston includes:
in response to an increased need for power, adjusting the linkage to increase the ratio of the length of the second stroke to the length of the fourth stroke; and
in response to a decreased need for power, adjusting the linkage to decrease the ratio of the length of the second stroke to the length of the fourth stroke.

17. The method of claim 14, wherein adjusting the linkage to adjust the ratio of the length of the second stroke to the length of the fourth stroke includes adjusting the linkage to decrease a length of the second stroke and the ratio of the length of the second stroke to the length of the fourth stroke.

18. The method of claim 13, wherein controlling the motion of the piston includes constraining the motion of the first link member in such a manner that the first link member sweeps forward and back once through a sweep angle during each revolution of the rotary member.

19. The method of claim 18, wherein:
the linkage further includes a second link member and an adjustable stationary pivot about which the second link member is pivotal; and
adjusting the linkage to adjust the motion of the piston includes adjusting the position of the adjustable stationary pivot.

20. The method of claim 13, wherein:
the linkage further includes a second link member and an adjustable stationary pivot about which the second link member is pivotal; and
adjusting the linkage to adjust the motion of the piston includes adjusting the position of the adjustable stationary pivot.

21. The method of claim 13, wherein adjusting the linkage includes adjusting one or more adjustable stationary guides of the linkage.

22. A machine, comprising:
a rotary member;
a first piston disposed within a first chamber;
a first linkage connecting the first piston to the rotary member in such a manner to cause the first piston to reciprocate during rotation of the rotary member, wherein the first linkage includes one or more adjusters configured to adjust the first linkage;
a second piston disposed within a second chamber; and
a second linkage connecting the second piston to the rotary member in such a manner to cause the second piston to reciprocate during rotation of the rotary member, the second linkage being non-adjustable.

23. The machine engine of claim 22, wherein:
the machine is an internal combustion engine; and
the one or more adjusters are configured to allow adjustment of a ratio of a length of an intake stroke of the first piston to a length of a power stroke of the first piston.

24. The machine of claim 23, further including an aspiration system connected to the second chamber, the aspiration system having an operating state wherein aspiration of the second chamber is prevented.

25. The machine of claim 24, further including engine controls configured to execute a control method including:
selectively operating the machine in a first state wherein the first linkage is adjusted to provide a first ratio of the length of the intake stroke of the first piston to the length of the power stroke of the first piston and the aspiration system aspirates the second chamber; and
selectively operating the machine in a second state wherein the first linkage is adjusted to provide a second ratio, lower than the first ratio, of the length of the intake stroke to the length of the power stroke of the first piston and the aspiration system prevents aspiration of the second chamber.

26. The machine of claim 24, wherein:
the rotary member is rotatable about a first axis; and
the first linkage includes a first link member, the first link member being connected to the rotary member in a manner limiting relative rotation between the first link member and the rotary member to relative rotation about a second axis disposed at an angle to the first axis.

27. The machine of claim 23, wherein:
the rotary member is rotatable about a first axis; and
the first linkage includes a first link member, the first link member being connected to the rotary member in a manner limiting relative rotation between the first link member and the rotary member to relative rotation about a second axis disposed at an angle to the first axis.

28. The machine of claim 22, wherein:
the rotary member is rotatable about a first axis; and
the first linkage includes a first link member, the first link member being connected to the rotary member in a manner limiting relative rotation between the first link member and the rotary member to relative rotation about a second axis disposed at an angle to the first axis.

29. The machine of claim 22, further including:
a third piston disposed in a third chamber;
a third linkage connecting the third piston to the rotary member in such a manner to cause the third piston to reciprocate during rotation of the rotary member about the first axis, wherein the third linkage includes one or more adjusters for adjusting the first linkage; and
wherein the third piston and third linkage are disposed on a side of the second piston and second linkage opposite the first piston and first linkage.

30. The machine of claim 29, wherein the machine is an internal combustion engine.

31. The machine of claim 22, wherein the machine is an internal combustion engine.
